(19) United States
(12) Patent Application Publication
(10) Pub. No.: US 2020/0021730 A1
(43) Pub. Date: Jan. 16, 2020

(54) VEHICULAR IMAGE PICKUP DEVICE AND IMAGE CAPTURING METHOD

(71) Applicant: GETAC TECHNOLOGY CORPORATION, Hsinchu County (TW)

(72) Inventor: Kun-Yu TSAI, Taipei City (TW)

(21) Appl. No.: 16/034,118

(22) Filed: Jul. 12, 2018

(51) Int. Cl. H04N 5/235; H04N 5/243; G06K 9/00; B60R 1/00

(52) U.S. Cl. CPC H04N 5/2352; H04N 5/2353; H04N 5/243; B60R 2300/30; G06K 9/00825; B60R 1/00; G06K 2209/15; H04N 5/2354

(57) ABSTRACT

A vehicular image pickup device includes an image capturing unit, a fill light unit and a processing unit. The image capturing unit captures a driving image. The fill light unit provides a fill light of a fill light intensity. The processing unit obtains, by conversion, a frequency spectrum of the driving image, detects a frequency domain location in the frequency spectrum, and fine-tunes a shutter speed of the image capturing unit, a gain of the image capturing unit or the fill light intensity of the fill light unit according to whether a signal appears at the frequency domain location in the frequency spectrum.

### BACKGROUND OF THE INVENTION

### Field of the Invention

The present disclosure relates to image capturing technology and, more particularly, to a vehicular image pickup device and an image capturing method.

### Description of the Prior Art

Image pickup devices are capable of recording images and thus have wide application, including ones installed at entrances and exits of buildings which require surveillance, to assist with tasks, such as conducting an investigation, preserving and collecting evidence.

Normally, conventional image pickup devices are each installed at a specific point to capture images within its image capturing radius according to an invariable operation model. However, if a conventional image pickup device is mounted on a moving object, for example, a vehicle, image quality of images captured by the image pickup device deteriorates, depending on the speed of the moving object. Furthermore, accuracy of ensuing recognition of the captured images is affected.

### SUMMARY OF THE INVENTION

In an embodiment, an image capturing method comprises the steps of: capturing a driving image by an image capturing unit; obtaining, by conversion, a frequency spectrum of the driving image, detecting a frequency domain location in the frequency spectrum, and fine-tuning a shutter speed of the image capturing unit and a gain of the image capturing unit or a fill light intensity of a fill light unit according to whether a signal appears at the frequency domain location in the frequency spectrum.

In an embodiment, a vehicular image pickup device comprises an image capturing unit, a fill light unit and a processing unit. The image capturing unit captures a driving image. The fill light unit provides a fill light of a fill light intensity. The processing unit obtains, by conversion, a frequency spectrum of the driving image, detecting a frequency domain location in the frequency spectrum, detects the frequency domain location in the frequency spectrum, and fine-tunes a shutter speed of the image capturing unit, a gain of the image capturing unit or the fill light intensity of the fill light unit according to whether a signal appears at the frequency domain location in the frequency spectrum.

In conclusion, a vehicular image pickup device and an image capturing method in the embodiments of the present disclosure fine-tune a shutter speed, a fill light intensity or a gain according to whether a signal appears at a frequency domain location in a frequency spectrum of driving images, so as to obtain the driving images capable of enhanced detailed performance. Furthermore, the vehicular image pickup device and the image capturing method in the embodiments of the present disclosure dispense with the need to wait for feedback from a back-end system and thus are capable of confirming the image quality of the driving images and performing fine-tuning operation instantly; hence, the driving images of enhanced image quality can be quickly obtained.

Fine structures and advantages of the present disclosure are described below with reference to preferred embodiments of the present disclosure to enable persons skilled in the art to gain insight into the technical features of the present disclosure and implement the present disclosure accordingly. Persons skilled in the art can easily understand the objectives and advantages of the present disclosure by making reference to the disclosure contained in the specification, the claims, and the drawings.

### BRIEF DESCRIPTION OF THE DRAWINGS

FIG. 1 is a block diagram of a vehicular image pickup device according to an embodiment of the present disclosure;

FIG. 2 is a schematic view of a process flow of an image capturing method according to an embodiment of the present disclosure;

FIG. 3 is a schematic view of driving images according to an embodiment of the present disclosure;

FIG. 4 is a schematic view of driving images according to an embodiment of the present disclosure;

FIG. 5 is a schematic view of driving images according to an embodiment of the present disclosure; and

FIG. 6 is a schematic view of a process flow of step S40 in FIG. 2 according to an embodiment of the present disclosure.

### DETAILED DESCRIPTION OF THE EMBODIMENTS

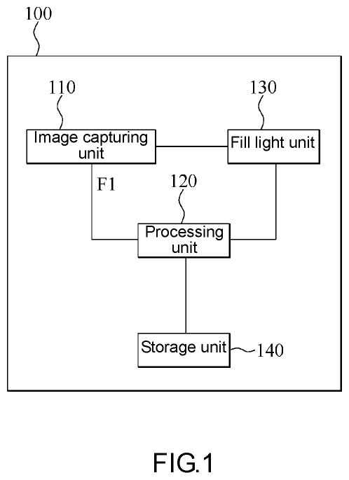

FIG. 1 is a block diagram of a vehicular image pickup device 100 according to an embodiment of the present disclosure. Referring to FIG. 1, in general, the vehicular image pickup device 100 is mounted on a means of transport and adapted to capture and record a driving image F1. In some embodiment aspects, the means of transport is a car or a motorcycle, but the present disclosure is not limited thereto. Any appropriate means of transport, which is suitable for use with the vehicular image pickup device 100, is applicable to the present disclosure.

In an embodiment, the vehicular image pickup device 100 comprises an image capturing unit 110 and a processing unit 120. The processing unit 120 is coupled to the image capturing unit 110. The vehicular image pickup device 100 further comprises a fill light unit 130. The fill light unit 130 is coupled to the image capturing unit 110 and the processing unit 120. The image capturing unit 110 captures the driving image F1. The fill light unit 130 outputs a fill light of a fill light intensity, i.e., a supplementary light, so as to assist with the image-capturing function of the image capturing unit 110.

In some embodiment aspects, the image capturing unit 110 comprises an assembly of lenses and light-sensing components. The light-sensing components include, for example, a complementary metal-oxide semiconductor (CMOS) and a charge-coupled device (CCD). The fill light unit 130 is, for example, implemented by a light-emitting diode (LED), an infrared LED (IR LED), a halogen lamp, or a laser source, but the present disclosure is not limited thereto.

The processing unit 120 controls and adjusts the operation of the image capturing unit 110 and/or the fill light unit 130 according to the image capturing method in any embodiment of the present disclosure to enhance the image quality of the driving images F1 captured by the image capturing unit 110.

In some embodiment aspects, the processing unit 120 is, for example, a system-on-a-chip (SoC), a central processing unit (CPU), a microcontroller (MCU), or an application-specific integrated circuit (ASIC).

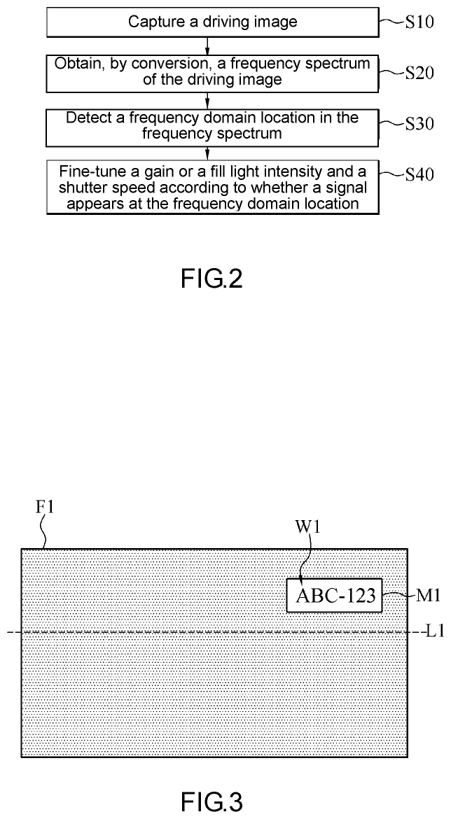

FIG. 2 is a schematic view of a process flow of an image capturing method according to an embodiment of the present disclosure. Referring to FIG. 1 and FIG. 2, using an embodiment of the image capturing method, the processing unit 120 instructs the image capturing unit 110 to capture a driving image F1 (step S10). Afterward, the processing unit 120 performs frequency domain conversion on the driving image F1 to obtain, by conversion, a frequency spectrum of the driving image F1 (step S20). Then, the processing unit 120 detects a frequency domain location in the frequency spectrum (step S30) and fine-tunes a gain of the image capturing unit 110 or the fill light intensity of the fill light unit 130 and a shutter speed of the image capturing unit 110 according to whether a signal appears at the frequency domain location (step S40), so as to optimize the image quality of the images captured by the vehicular image pickup device 100 by the aforesaid fine-tuning operations.

In an embodiment of step S10, the image capturing unit 110 captures each driving image F1 with a global shutter, but the present disclosure is not limited thereto. In a variant embodiment of step S10, the image capturing unit 110 captures each driving image F1 with a rolling shutter. Furthermore, the image capturing unit 110 captures each driving image F1 at a predetermined shutter speed in the presence of the fill light of the fill light unit 130. In some embodiment aspects, the predetermined shutter speed ranges from 1/1000 to 1/100000 per second.

In an embodiment of step S20, the frequency domain conversion is implemented by Fourier transform.

In some embodiments, the driving image F1 comprises a plurality of pixels. The pixels display grayscales according to one of grayscale levels. Hence, how the driving image F1 looks depends on the grayscales displayed by the pixels and their locations.

In some embodiment aspects, the driving image F1 consists of 1280*720 pixels, but the present disclosure is not limited thereto. In a variant embodiment, the driving image F1 consists of 360*240 pixels, 1920*1080 pixels, or any display standard-complying number of pixels.

In some embodiment aspects, the grayscale levels are in the number of 256, for example, from grayscale level 0 to grayscale level 255, with grayscale level 0 denoting the least brightness, and grayscale level 255 denoting the highest brightness, but the present disclosure is not limited thereto. In a variant embodiment, the number of the grayscale levels depends on the performance of the image capturing unit 110. For instance, the image capturing unit 110 comprises an analog-to-digital conversion circuit. If the analog-to-digital conversion circuit operates on a 10-bit basis, the image capturing unit 110 provides performance of 1024 (i.e., 2¹⁰) grayscale levels. The other cases are inferred by analogy.

In some embodiments, if an object is within an image capturing radius of the vehicular image pickup device 100, the driving image F1 captured by the image capturing unit 110 includes an object image M1. Furthermore, if the object bears any character, a character image W1 is present on the object image M1 in the driving image F1 captured by the image capturing unit 110.

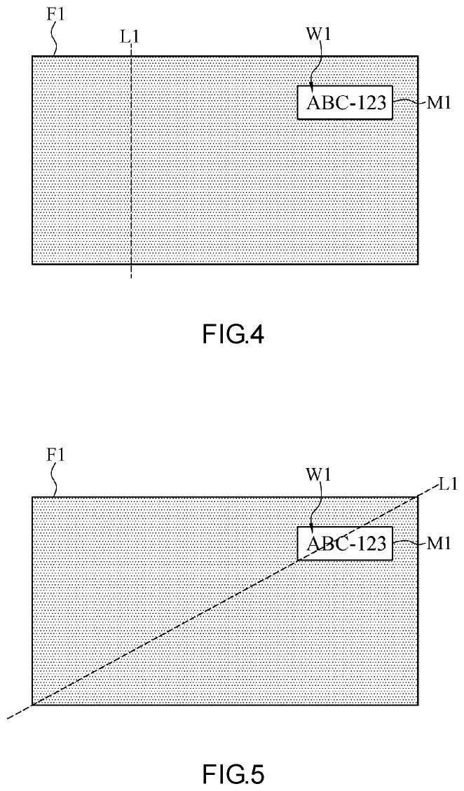

FIG. 3, FIG. 4 and FIG. 5 are schematic views of driving images according to an embodiment of the present disclosure, respectively. Referring to FIG. 1 through FIG. 5, in an embodiment of step S30, the object image M1 comprises a plurality of character images W1. The processing unit 120 defines a straight line L1 penetrating the driving images F1 and thus obtains a frequency domain location according to the number of pixels on the straight line L1 penetrating the driving images F1 and the number of pixels displaying the character images W1 and aligned in the same direction as the straight line L1. In some embodiment aspects, the frequency domain location is a high frequency location in the frequency spectrum.

The description below is exemplified by the driving image F1 with an image format of 1280*720. If the driving image F1 has an image format of 1280*720, it means that the driving image F1 has 1280 pixels on the horizontal axis (i.e., X-axis) and 720 pixels on the vertical axis (i.e., Y-axis), and thus the driving image F1 consists of 1280*720 pixels. If the processing unit 120 defines the straight line L1 which runs along the horizontal axis of the driving image F1, as shown in FIG. 3, the straight line L1 must penetrate 1280 pixels in the driving image F1. The number of pixels (along the straight line L1) displaying the character images W1 equals the number (say, 3˜10) of pixels required for recognition of the character images W1. In this regard, the description below is exemplified by three pixels. Therefore, the processing unit 120 detects 3/1280 frequency domain locations, but the present disclosure is not limited thereto. In a variant embodiment, the straight line L1 penetrating the driving image F1 runs along the vertical axis of the driving image F1 as shown in FIG. 4 or in any other appropriate direction. In an embodiment illustrated by FIG. 5, the straight line L1 penetrating the driving image F1 runs along a direction which forms an included angle of 45 degrees with the horizontal axis of the driving image F1.

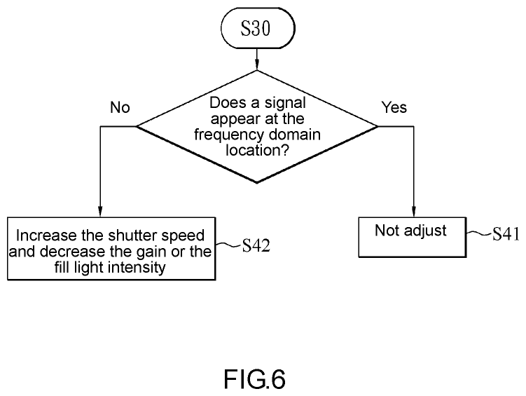

FIG. 6 is a schematic view of a process flow of step S40 in FIG. 2 according to an embodiment of the present disclosure. Referring to FIG. 1 through FIG. 6, in an embodiment of step S40, if the processing unit 120 in step S30 detects that a signal appears at the frequency domain location, the processing unit 120 determines that the driving image F1 has sufficient sharpness and thus does not adjust the gain and shutter speed of the image capturing unit 110 and the fill light intensity of the fill light unit 130 (step S41). If the processing unit 120 in step S30 detects no signal at the frequency domain location, the processing unit 120 determines that the driving image F1 is not sharp enough, that is, is blurred, and thus the processing unit 120 increases the shutter speed of the image capturing unit 110 and decreases one of the gain of the image capturing unit 110 and the fill light intensity of the fill light unit 130 (step S42). Therefore, the driving images F1 captured by the image capturing unit 110 after the fine-tuning operations have sufficient brightness and sharpness and thus are capable of enhanced detailed performance.

In some embodiments, the processing unit 120 performs step S10 through step S40 repeatedly to effectuate fine-tuning repeatedly such that the driving images F1 captured by the image capturing unit 110 is capable of sufficiently high frequency spectrum responses.

In some embodiments, before performing step S20, the processing unit 120 sets the shutter speed of the image capturing unit 110 preliminarily such that the driving images F1 captured by the image capturing unit 110 do not blur. For instance, in step S10, the processing unit 120 instructs the image capturing unit 110 to capture a plurality of driving images F1 sequentially and then set the shutter speed of the image capturing unit 110 according to a result of image analysis of two of the driving images F1.

In an embodiment, the processing unit 120 chooses any two of the driving images F1 on condition that the two chosen driving images F1 include the object image M1. Then, the processing unit 120 performs image analysis on the two chosen driving images F1 in order to obtain a variance of the object image M1. Afterward, the processing unit 120 sets the shutter speed of the image capturing unit 110 according to the variance obtained. In an embodiment aspect, the processing unit 120 performs image analysis on the first one of the driving images F1 and the last one of the driving images F1 on condition that both the first and last ones of the driving images F1 include the object image M1. The variance obtained is equivalent to the time difference between the points in time when the object image M1 appears in the two driving images F1, respectively. In another embodiment aspect, the processing unit 120 performs image analysis on two consecutively captured driving images F1 which include the object image M1. The variance obtained as a result of the image analysis performed by the processing unit 120 is the displacement (i.e., variance in location) of the object image M1 in the two driving images F1; hence, the variance is location variance, for example, the distance traveled by the object image M1 along the X-axis in the two driving images F1, but the present disclosure is not limited thereto. In a variant embodiment, the variance obtained by the processing unit 120 is the speed at which the object image M1 in the two driving images F1 moves.

In some embodiment aspects, the processing unit 120 obtains the variance of the object image M1 by image subtraction, but the present disclosure is not limited thereto. In a variant embodiment, the processing unit 120 obtains the variance of the object image M1 by any appropriate image analysis algorithm.

Before performing step S20, the processing unit 120 performs preliminary adjustment of the fill light intensity of the fill light unit 130 or the gain of the image capturing unit 110 such that the driving images F1 captured by the image capturing unit 110 have appropriate brightness. For instance, the processing unit 120 obtains, by conversion, a histogram of the driving images F1 by image integration and thus obtains a grayscale quantity distribution of the pixels of the driving images F1 on a plurality of grayscale levels. Then, the processing unit 120 numbers the pixels sequentially in the direction from the highest grayscale level to the lowest grayscale level according to the grayscale quantity distribution obtained by conversion, until the numbering reaches a predetermined number. Afterward, the processing unit 120 fine-tunes the fill light intensity or gain according to the grayscale level of the pixel whose number is the predetermined number such that the highest brightness of the driving images F1 can be adjusted to a reasonable range without becoming too bright or too dim.

In an embodiment, the predetermined number equals the number of pixels generally occupied by the object image M1 in the driving images F1. In some embodiment aspects, if the object image M1 is an image of a license plate, the predetermined number ranges from 1000 to 3000 or ranges from 2000 to 3000, but the present disclosure is not limited thereto. In a variant embodiment, the predetermined number depends on the number of pixels which must be occupied by the image of the license plate in order to correctly recognize every country's license plates and sizes thereof.

In some embodiments, given the appropriate shutter speed and fill light intensity or gain, the processing unit 120 performs the fine-tuning operation of step S10 through step S40 of the image capturing method to further augment the detailed performance of the driving images F1.

In some embodiments, the product of the shutter speed and gain of the image capturing unit 110 and the fill light intensity of the fill light unit 130 before and after the fine-tuning operation of step S40 remains the same. For instance, if the processing unit 120 enables the shutter speed to reduce to a half thereof, the processing unit 120 enables the gain or fill light intensity to double; hence, the product of the shutter speed, gain and fill light intensity is substantially the same before and after the fine-tuning operation; in other words, the fine-tuning operation brings no great change in the product of the shutter speed, gain and fill light intensity.

In some embodiments, the vehicular image pickup device 100 further comprises a storage unit 140. The storage unit 140 is coupled to the processing unit 120. The storage unit 140 stores any parameters for use in the image capturing method in any embodiment of the present disclosure, for example, the predetermined number, the shutter speed, the fill light intensity and/or gain.

In some embodiments, the vehicular image pickup device 100 is for use in a detection system of the police forces. For instance, the vehicular image pickup device 100 is mounted on a police car. The vehicular image pickup device 100 is electrically connected to an internal system of the police car, and the internal system sends the captured driving image F1 to a back-end system. The back-end system performs post-processing and image recognition on the driving image F1, and thus assists the police in quickly recording and recognizing license plates and car models. The object image M1 in the driving image F1 is an image of a license plate or an image of the car body. The character images W1 are images of numerals or characters.

In conclusion, a vehicular image pickup device and an image capturing method in the embodiments of the present disclosure fine-tune a shutter speed, fill light intensity or gain according to whether a signal appears at a frequency domain location in a frequency spectrum of driving images so as to obtain the driving images capable of enhanced detailed performance. Furthermore, the vehicular image pickup device and the image capturing method in the embodiments of the present disclosure dispense with the need to wait for feedback from a back-end system and thus are capable of confirming the image quality of the driving images and performing fine-tuning operation instantly; hence, the driving images of enhanced image quality can be quickly obtained.

Although the present disclosure is disclosed above by preferred embodiments, the preferred embodiments are not restrictive of the present disclosure. Changes and modifications made by persons skilled in the art to the preferred embodiments without departing from the spirit of the present disclosure must be deemed falling within the scope of the present disclosure. Accordingly, the legal protection for the present disclosure should be defined by the appended claims.

1. An image capturing method, comprising the steps of:
capturing a driving image by an image capturing unit;
obtaining, by conversion, a frequency spectrum of the driving image;
detecting a high frequency domain location in the frequency spectrum; and
fine-tuning a shutter speed of the image capturing unit, as well as a gain of the image capturing unit or a fill light intensity of a fill light unit, according to whether a signal appears at the high frequency domain location in the frequency spectrum;
wherein the step of fine-tuning the shutter speed or the gain of the image capturing unit and the fill light intensity of the fill light unit comprises:
in response to a signal appearing at the high frequency domain location, not adjusting the shutter speed, the gain or the fill light intensity; and
in response to no signal appearing at the high frequency domain location, increasing the shutter speed and decreasing the fill light intensity or the gain.

2. (canceled)

3. The image capturing method of claim 1, wherein the high frequency domain location is obtained according to the number of pixels on a straight line penetrating the driving image and the number of pixels displaying a character image and aligned in the same direction as the straight line.

4. The image capturing method of claim 1, wherein a product of the shutter speed, the gain and the fill light intensity is the same before and after the fine-tuning.

5. A vehicular image pickup device, comprising:
an image capturing unit for capturing a driving image;
a fill light unit for providing a fill light of a fill light intensity; and
a processing unit configured to obtain, by conversion, a frequency spectrum of the driving image, detect a high frequency domain location in the frequency spectrum, and fine-tune a shutter speed of the image capturing unit, as well as a gain of the image capturing unit or the fill light intensity, according to whether a signal appears at the high frequency domain location in the frequency spectrum; and
wherein the processing unit is further configured not to adjust the shutter speed, the gain or the fill light intensity if a signal appears at the high frequency domain location, and configured to increase the shutter speed and to decrease the fill light intensity or the gain if no signal appears at the high frequency domain location.

6. (canceled)

7. The vehicular image pickup device of claim 5, wherein the processing unit obtains the high frequency domain location according to the number of pixels on a straight line penetrating the driving image and the number of pixels displaying a character image and aligned in the same direction as the straight line.

8. The vehicular image pickup device of claim 5, wherein a product of the shutter speed, the gain and the fill light intensity is the same before and after the fine-tuning.
